(19) United States
(12) Patent Application Publication
(10) Pub. No.: US 2020/0277163 A1
(43) Pub. Date: Sep. 3, 2020

(54) CONTROLLING MOVEMENT OF AN ELEVATOR CAR

(71) Applicant: Otis Elevator Company, Farmington, CT (US)

(72) Inventors: Aurelien Fauconnet, Isdes (FR); Gerard Sirigu, Gien (FR)

(21) Appl. No.: 16/721,400

(22) Filed: Dec. 19, 2019

(30) Foreign Application Priority Data
Mar. 1, 2019 (EP) 19160328.1

(51) Int. Cl. B66B 11/02; B66B 5/00; B66B 3/00; B66B 5/02; B66B 1/50

(52) U.S. Cl. CPC B66B 11/0246; B66B 5/005; B66B 1/50; B66B 3/002; B66B 5/025; B66B 5/0012

(57) ABSTRACT

An elevator car (60) defining an interior space (61) comprises at least one opening (66) providing a passage between the interior space (61) and the exterior of the elevator car (60), and at least one sensor (82) configured for detecting any object (75) extending through the at least one opening (66).

### FOREIGN PRIORITY

This application claims priority to European Patent Application No. 19160328.1, filed Mar. 1, 2019, and all the benefits accruing therefrom under 35 U.S.C. § 119, the contents of which in its entirety are herein incorporated by reference.

### BACKGROUND

The invention relates to a method of controlling movement of an elevator car within a hoistway of an elevator system. The invention further relates to an elevator system comprising an elevator drive which is configured for employing such a method.

An elevator system comprises an elevator car moving along a hoistway extending between a plurality of landings, and an elevator drive configured for driving the elevator car.

The elevator system may comprise components arranged within the hoistway outside the elevator car, which need to be accessed for maintenance and/or repair. The elevator car may comprise at least one opening allowing a mechanic to access such components by reaching out of the elevator car. When the elevator car moves or starts to move while a mechanic is reaching out of the elevator car, there is a risk that parts of the human body of the mechanic are squeezed between the elevator car and the hoistway.

It therefore is desirable to prevent the elevator car from moving while a person is reaching out of an elevator car.

### SUMMARY

According to an exemplary embodiment of the invention, an elevator car defining an interior space comprises at least one opening providing a passage between the interior space and an exterior of the elevator car allowing a person within the interior space to reach out of the interior space, and at least one sensor configured for detecting any object extending through the at least one opening.

The at least one sensor may be connected with an alarm device issuing an acoustical/audible and/or optical/visible alarm when an object extending through the at least one opening is detected. Alternatively or additionally, the at least one sensor may issue a signal to an elevator drive, in particular to a controller, of the elevator system for preventing any movement of the elevator car when an object extending through the at least one opening is detected.

The object detected by the sensor in particular may be a part of human body, such as a head, an arm and/or a foot, of a mechanic reaching out of the elevator car.

Exemplary embodiments of the invention further include an elevator system comprising a hoistway extending between a plurality of landings; at least one elevator car according to an exemplary embodiment of the invention, which is configured for moving along the hoistway between the plurality of landings; and an elevator drive configured for moving the elevator car along the hoistway. In such an elevator system, the at least one sensor of the elevator car may be connected with the elevator drive and configured for preventing any movement of the elevator car when an object extending through the at least one opening is detected.

Exemplary embodiments of the invention further include a method of moving an elevator car in such an elevator system. The method includes providing input to the elevator drive via an input device; moving the elevator car according to said input; and stopping and preventing any movement of the elevator car when the sensor detects an object, in particular a part of a human body, extending through the at least one opening.

Exemplary embodiments of the invention also include a method of moving an elevator car in such an elevator system, wherein the method includes providing input to the elevator drive via an input device; moving the elevator car according to said input; determining the current position of the elevator car; and stopping and preventing any movement of the elevator, when the sensor detects an object, in particular a part of a human body, extending through the at least one opening, and the determined position of the elevator car is within a predetermined distance from an end of the hoistway and/or the elevator car is moving towards said end of the hoistway reducing the distance between the elevator car and said end of the hoistway.

Exemplary embodiments of the invention further include a method of maintaining and/or repairing an elevator system according to an exemplary embodiment of the invention, wherein the method includes employing the method according to an exemplary embodiment of the invention for moving the at least one elevator car to a predetermined position within the hoistway, stopping the at least one elevator car at said predetermined position, and accessing a component of the elevator system outside the at least one elevator car by reaching through the at least one opening of the elevator car.

Exemplary embodiments of the invention allow for safe operation, maintenance and repair of an elevator system, in particular including accessing components of the elevator system within the hoistway, even when a person, in particular a mechanic, is reaching out of the elevator car into the hoistway.

Exemplary embodiments of the invention allow reducing the clearance between the elevator car and components arranged within the hoistway requested by the safety code (EN81-20). According to exemplary embodiments of the invention, the mechanic will be obliged to stay inside the interior space of the elevator car when the elevator car is moving. This avoids all risk of the mechanic being sheared or crushed between the elevator car and components arranged within the hoistway.

A number of optional features are set out in the following. These features may be realized in particular embodiments, alone or in combination with any of the other features, unless specified otherwise.

The at least one sensor may include at least one light emitter and at least one light detector, in particular a laser and a laser detector, constituting a light barrier for detecting an object extending through the opening by interrupting the light barrier.

The at least one sensor may include an ultrasound emitter and a corresponding ultrasound receiver, or a radar wave emitter and a corresponding radar wave receiver for detecting an object extending through the opening due to ultrasound or radar waves reflected by said object.

The at least one sensor may include an optical camera for detecting an object extending through the opening in at least one picture taken by the camera.

For providing safe and convenient access through the at least one opening, the elevator car may comprise a platform allowing a person standing on the platform to reach trough the at least one opening. The platform may be movable between a storage position, in which it does not interfere with passengers within the elevator car, and a working position, in which it provides access to the at least one opening.

Depending on the position of the components, which are to be accessed, within the hoistway, an opening may be formed within the top (ceiling), bottom (floor) and/or within at least one sidewall of the elevator car.

In order to allow a mechanic to move the elevator car to a desired position within the hoistway, an elevator system according to an exemplary embodiment of the invention may comprise an input device provided within or at the elevator car, the input device being configured for receiving and transmitting manual inputs to the elevator drive for controlling the movement of the elevator car.

### DRAWING DESCRIPTION

In the following, an exemplary embodiment of the invention is described in more detail with reference to the enclosed figures.

FIG. 1 schematically depicts an elevator system comprising an elevator car configured for moving along a hoistway.

FIGS. 2 and 3 depict perspective views of an elevator car with a platform arranged in a working position.

FIGS. 4 and 5 depict perspective views of an elevator car comprising a platform arranged in a working position and a sensor according to an exemplary embodiment of the invention.

### DETAILED DESCRIPTION

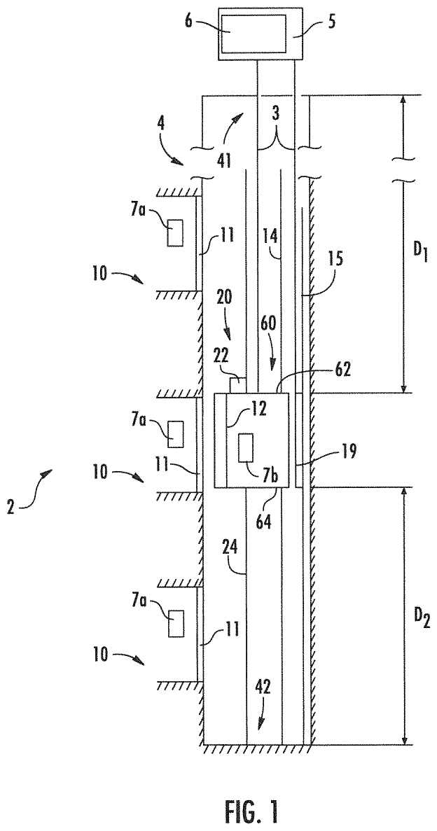

FIG. 1 schematically depicts an elevator system 2.

The elevator system 2 includes an elevator car 60 movably arranged within a hoistway 4 extending between a plurality of landings 10. The elevator car 60 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 60 is shown in FIG. 1, the skilled person understands that exemplary embodiments of the invention may include elevator systems 2 including a plurality of elevator cars 60 moving in one or more hoistways 4.

The elevator car 60 comprises a top (ceiling) 62, a bottom (floor) 64 and a plurality of sidewalls 65 extending between the top 62 and the bottom 64 of the elevator car 60 defining an interior space 61 of the elevator car 60.

The elevator car 60 is movably suspended by means of a tension member 3. The tension member 3, for example a rope or belt, is connected to an elevator drive 5, which is configured for driving the tension member 3 in order to move the elevator car 60 along the height of the hoistway 4 between the plurality of landings 10, which are located on different floors.

The exemplary embodiment shown in FIG. 1 uses a 1:1 roping for suspending the elevator car 60. The skilled person, however, easily understands that the type of the roping is not essential for the invention and that different kinds of roping, e.g. a 2:1 roping or a 4:1 roping may be used as well.

The tension member 3 may be a rope, e.g. a steel wire rope, or a belt. The tension member 3 may be uncoated or may have a coating, e.g. in the form of a polymer jacket. In a particular embodiment, the tension member 3 may be a belt comprising a plurality of polymer coated steel cords (not shown). The elevator system 2 may have a traction drive including a traction sheave for driving the tension member 3. In an alternative configuration, which is not shown in the figures, the elevator system 2 may be an elevator system 2 without a tension member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the tension member 3 and configured for moving concurrently and in opposite direction with respect to the elevator car 60 along at least one counterweight guide member 15. The skilled person will understand that the invention may be applied also to elevator systems 2 which do not comprise a counterweight 19.

Each landing 10 is provided with a landing door 11, and the elevator car 60 is provided with a corresponding elevator car door 12 for allowing passengers to transfer between a landing 10 and the interior of the elevator car 60 when the elevator car 60 is positioned at the respective landing 10.

The elevator drive 5 includes an elevator controller 6 which is configured for controlling the elevator drive 5 for moving the elevator car 60 along the hoistway 4 between the different landings 10.

Input to the elevator drive 5, in particular to the controller 6, may be provided via landing control panels 7a, which are provided on each landing 10 close to the landing doors 11, and/or via an elevator car control panel 7b, which is provided inside the elevator car 60.

The landing control panels 7a and the elevator car control panel 7b may be connected with the elevator drive 5 by means of electric wires, which are not shown in FIG. 1, in particular by an electric bus, or by means of wireless data connections.

The elevator car 60 may be equipped with at least one position reference system 20, which is configured for detecting and/or determining the position of the elevator car 60 within the hoistway 4.

The position reference system 20 may be an absolute position reference system 20, including a position detector 22 configured for interacting with a coded tape 24 extending along the length of the hoistway 4. Alternatively or additionally, the position reference system 20 may comprise a position detector 22 which is configured for determining the current position of the elevator car 60 within the hoistway 4 by detecting and integrating velocities and/or accelerations of the elevator car 60.

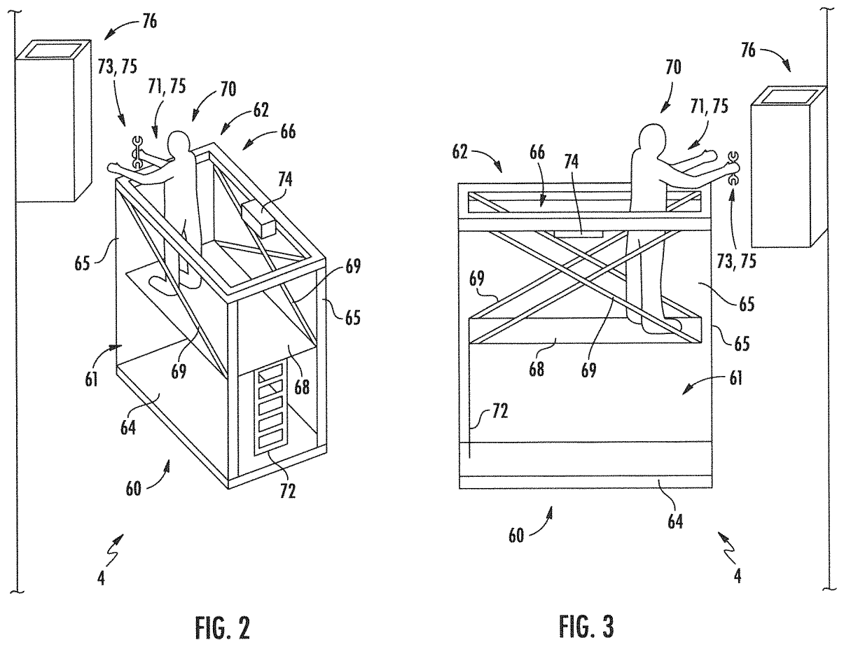

FIGS. 2 to 5 depict perspective views of an elevator car 60 according to an exemplary embodiment of the invention during maintenance and/or repair procedures.

For accessing a component 76 of the elevator system 2 located within the hoistway 4 outside the elevator car 60, a mechanic 70 within the interior space 61 of the elevator car has opened an opening 66 provided at the top 62 of the elevator car 60 allowing him to reach through the top 62 of the elevator car 60 for accessing the component 76. The mechanic 70 may use at least one tool 73 when working on said component 76.

In the exemplary embodiment depicted in FIGS. 2 to 5, the opening 66 extends basically completely over the top 62 of the elevator car 60. In alternative embodiments, which are not explicitly depicted in the figures, the opening 66 may extend only over a portion of the top 62 of the elevator car 60 and/or the elevator car 60 may comprise two or more openings 66 provided at different positions at the top 62 of the elevator car 60.

Similar openings (not shown) may be formed within the bottom 64 and/or within at least one sidewall 65 of the elevator car 60, respectively.

The elevator car 60 may comprise a movable platform 68, which is movable between a storage position (not shown), e.g. at the top 62 or at the bottom 64 of the interior space 61, and a working position, in which it is depicted in FIGS. 2 to 5. When the platform 68 is arranged in the working position, a mechanic 70 may step onto the platform 68 for reaching through an opening 66 in the upper part of the elevator car 60.

The platform 68 may be mounted to the elevator car 60 by at least one scissor mechanism 69 extending between the platform 68 and the top 62 of the elevator car 60, as it is exemplarily depicted in FIGS. 2 to 5. A ladder 72 may be provided for allowing the mechanic 70 to climb conveniently onto the platform 68 when it is arranged in the working position in some distance above the bottom 64 of the elevator car 60.

When the mechanic 70 is reaching through the opening 66, at least some parts of his body are located within the hoistway 4 outside the interior space 61 of the elevator car 60.

Thus, in case the elevator car 60 moves while the mechanic 70 is reaching through the opening 66, there is some risk that parts 71 of the mechanic's body are squeezed between the elevator car 60 and the top, walls or bottom of the hoistway 4.

It therefore is desirable to prevent any movement of the elevator car 60 while the mechanic 70 is reaching through an opening 66 of the elevator car 60 into the hoistway 4.

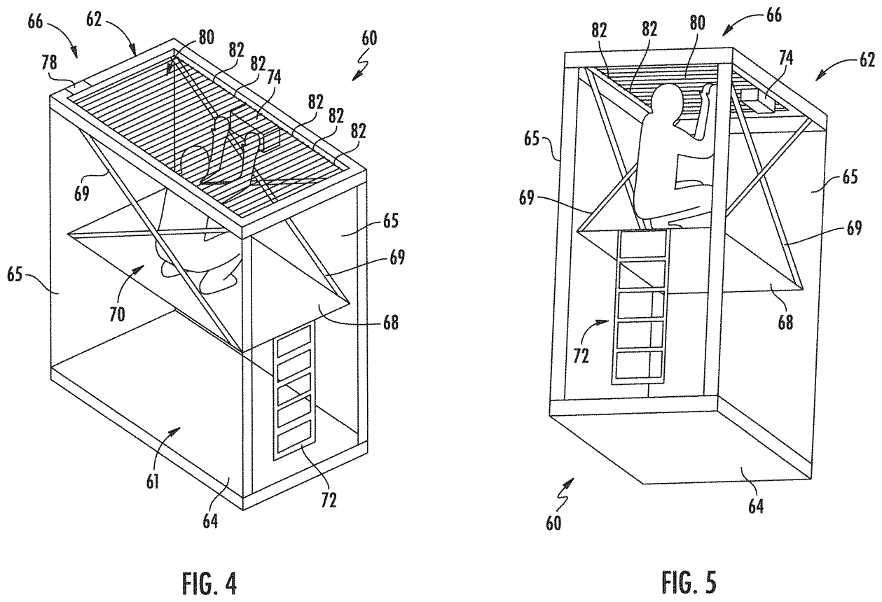

According to an exemplary embodiment of the invention, the elevator car 2 is equipped with at least one sensor 82 (see FIGS. 4 and 5), which is configured for monitoring an opening 66 of the elevator car 60 and for detecting any object 75, in particular any tools 73 used by the mechanic 70 or parts 71 of a human body, extending through said opening 66.

In the embodiment depicted in FIGS. 4 and 5 a plurality of sensors 82 are provided next to each other establishing a virtual safety curtain 80 extending across the opening 66. For clarity of the illustration, not all sensors 82 are provided with reference signs in FIGS. 4 and 5.

The at least one sensor 82 is connected with the elevator drive 5, in particular the controller 6. The elevator drive 5 is configured for stopping and/or preventing any movement of the elevator car 60 when the at least one sensor 82 detects any object 75, in particular a tool 73 or a part 71 of a human body, extending through the opening 66.

The at least one sensor 82 may be connected with the elevator drive 5 by means of electrical wires (not shown), including a bus system, such as a CAN bus, or by a wireless data connection.

The at least one sensor 82 may be implemented creating a light barrier, in particular a light barrier including at least one laser light source, extending over the whole opening 66. Alternatively, the sensor 82 may constitute a plurality of light barriers, wherein each of the light barriers monitors a section of the opening 66.

Instead of creating a light barrier, the at least one sensor 82 may employ ultrasonic or radar waves for detecting any objects 75 extending though the opening 66, or it may comprise least one optical camera, which is configured for monitoring the opening 66 and detecting any objects 75 extending though the opening 66. Combination of different techniques are possible as well.

In an elevator system 2 according to an exemplary embodiment of the invention, the elevator car 60 is allowed to move only when all tools 73 and parts 71 of a human body, in particular of a mechanic 70 being present within the elevator car 60, are completely located within the interior space 61 of the elevator car 60 (see FIGS. 4 and 5), and in particular when no object 75 extends though the opening 66 of the elevator car 60.

An input device 74, in particular a manual service control device, may be provided within the elevator car 60. The input device 74 may be configured for allowing the mechanic 70 being present on the platform 68 to manually control the movement of the elevator car 60, in particular for moving the elevator car 60 to a position within the hoistway 4 which allows convenient access to a desired component 76 of the elevator system 2.

As an additional safety measure, the input device 74 may be positioned and configured so that the mechanic 70 is able to move the elevator car 60 by operating the input device 74 only when his body is completely within the interior space 61 of the elevator car 60.

Such a safety measure, however, might be circumvented by two mechanics 70 cooperating with each other, in particular by a first mechanic 70 reaching out of the opening 66 and a second mechanic 70 operating the input device 74.

In an elevator system 2 according to an exemplary embodiment of the invention, even such a cooperation of at least two mechanics 70 does not result in an unsafe situation, as any movement of the elevator car 60 is prevented when an object 75, in particular a tool 73 or a part 71 of a human body extends though the opening 66, as it has been described before.

Instead of, or in addition to, stopping and preventing any movement of the elevator car 60 when an object 75 extending through the opening 66 is detected, the elevator car 60 may be equipped with an alarm device 78 which is configured for issuing an acoustic and/or optical alarm signal in case an object 75 extending through the opening 66 is detected.

In a further configuration, the elevator drive 5 may be configured to allow movement of the elevator car 60 under certain circumstances despite an object 75 extending through the opening is detected.

For example, in case an object 75 extending through an opening 66 formed at the top 62 of the elevator car 60 is detected, the elevator drive 5 may allow the elevator car 60 to move downwards, as in case of a downward motion of the elevator car 60, there is no risk that an object 75 is squeezed between the top 62 of the elevator car 60 and the upper end 41 of the hoistway 4.

The elevator car 60 even may be allowed to move upwards even if an object 75 extending through an opening 66 formed at the top 62 of the elevator car 60 is detected, as long as a distance D₁ (see FIG. 1) between the top 62 of the elevator car 60 and the upper end 41 of the hoistway 4 is larger than a predetermined distance providing a sufficiently large safety space between the top 62 of the elevator car 60 and the upper end 41 of the hoistway 4.

Similarly, the elevator car 60 may be allowed to move upwards, in case an object 75 is detected as extending though an opening 66 formed within the bottom 64 of the elevator car 60.

The elevator car 60 even may be allowed to move downwards even if an object 75 extending through an opening 66 formed within the bottom 64 of the elevator car 60 is detected, as long as a distance D₂ (see FIG. 1) between the bottom 64 of the elevator car 60 and the lower end 42 of the hoistway 4 is larger than a predetermined distance providing a sufficiently large safety space between the bottom 64 of the elevator car 60 and the lower end 42 of the hoistway 4.

Optionally, the maximum allowable speed of the elevator car 60 may be reduced when the elevator car 60 is allowed to move despite an object 75 extending out of the elevator car 60 into the hoistway 4 is detected.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 elevator drive
6 elevator controller
7a landing control panel
7b elevator car control panel
10 landing
11 landing door
12 elevator car door
14 car guide member
15 counterweight guide member
19 counterweight
20 position reference system
22 position detector
24 coded tape
41 upper end of the hoistway
42 lower end of the hoistway
60 elevator car
61 interior space
62 top of the elevator car
64 bottom of the elevator car
65 sidewall
66 opening
68 platform
69 scissor mechanism
70 mechanic
71 part of a human body
72 ladder
73 tool
74 input device
75 object
76 component of the elevator system
78 alarm device
80 safety curtain
82 sensor
D₁ distance between the top of the elevator car and the upper end of the hoistway
D₂ distance between the bottom of the elevator car and the lower end of the hoistway

What is claimed is:

1. Elevator car (60) defining an interior space (61) comprising:
at least one opening (66) providing a passage between the interior space (61) and the exterior of the elevator car (60); and
at least one sensor (82) configured for detecting any object (75) extending through the at least one opening (66).

2. Elevator car (60) according to claim 1, wherein the object (75) is a part (71) of a human body or a tool (73) used by a mechanic (70).

3. Elevator car (60) according to claim 1, wherein the at least one sensor (82) is configured for establishing a virtual safety curtain (80) extending across the at least one opening (66).

4. Elevator car (60) according to claim 1, wherein the at least one sensor (82) includes at least one of a light emitter, in particular a laser emitter, a light detector, in particular a laser detector, an ultrasound emitter, an ultrasound receiver, a radar wave emitter, a radar wave receiver and an optical camera, or any combination thereof.

5. Elevator car (60) according to claim 1, further comprising a platform (68) allowing a mechanic (70) standing on the platform (68) to reach through the at least one opening (66).

6. Elevator car (60) according to claim 1, wherein the at least one opening (66) is formed at or in a top (62) of the elevator car (60).

7. Elevator car (60) according to claim 1, wherein the at least one opening (66) is formed in a bottom (64) of the elevator car (60).

8. Elevator car (60) according to claim 1, wherein the at least one opening (66) is formed in a sidewall (65) of the elevator car (60).

9. Elevator car (60) according to claim 1, wherein the at least one sensor (82) is configured for issuing an alarm signal when detecting an object (75) extending through the at least one opening (66).

10. Elevator system (2) comprising
a hoistway (4) extending between a plurality of landings (10);
at least one elevator car (60) according to claim 1 configured for moving along the hoistway (4) between the plurality of landings (10); and
an elevator drive (5) configured for moving the elevator car (60) along the hoistway (4).

11. Elevator system (2) according to claim 10 further wherein the elevator drive (5) is configured for preventing any movement of the elevator car (60) when the sensor (82) detects an object (75) extending through the at least one opening (66).

12. Elevator system (2) according to claim 11 comprising an input device (74) provided within or at the elevator car (60), the input device (74) being configured for receiving and transmitting manual inputs to the elevator drive (5) for controlling the movement of the elevator car (60).

13. Method of moving an elevator car (60) in an elevator system (2) according to claim 12, wherein the method includes:
providing input to the elevator drive (5) via the input device (74);
moving the elevator car (60) according to said input; and
stopping and preventing any movement of the elevator car (60) when the sensor (82) detects an object (75), in particular a part (71) of a human body or a tool (73), extending through the at least one opening (66).

14. Method of moving an elevator car (60) in an elevator system (2) according to claim 12, wherein the method includes:
providing input to the elevator drive (5) via the input device (74);
moving the elevator car (60) according to said input;
determining the current position of the elevator car (60); and
stopping and preventing any movement of the elevator car (60), when the sensor (82) detects an object (75), in particular a part (71) of a human body or a tool (73), extending through the at least one opening (66) and the determined position of the elevator car (60) is within a predetermined distance from an end of the hoistway (4) and/or the elevator car (60) is moving towards said end (41, 42) of the hoistway (4) reducing the distance between the elevator car (60) and the end (41, 42) of the hoistway (4) even further.

15. Method of maintaining and/or repairing an elevator system, wherein the method includes employing the method according to claim 13 for moving the at least one elevator car (60) to a predetermined position within the hoistway (4), stopping the at least one elevator car (60) at said predetermined position, and accessing a component (76) of the elevator system (2) outside the at least one elevator car (60) by reaching through the at least one opening (66).
